(19) United States
(12) Patent Application Publication
(10) Pub. No.: US 2004/0084155 A1
(43) Pub. Date: May 6, 2004

(54) Apparatus for rewinding paper into rolls discontinuously without stopping unwinding

(76) Inventor: Giovanni Gambini, Pisa (IT)

Correspondence Address: James V. Costigan, Esq., Hedman & Costigan, P.C., Suite 2003, 1185 Avenue of the Americas, New York, NY, 10036-2646, US

(21) Appl. No.: 10/697,827

(22) Filed: Oct. 30, 2003

(30) Foreign Application Priority Data
Nov. 6, 2002 (IT) MI2002A 002351

(51) Int. Cl. B32B 31/00

(52) U.S. Cl. 156/446; 156/459

(57) ABSTRACT

An apparatus for rewinding paper into rolls discontinuously without stopping unwinding comprising an unwinding device of at least two plies of paper arranged in series with an embossing device of the at least two plies and with a rereeling machine which stops when a log is completed, wherein a gluing device of the at least two plies of paper and an build up device of the at least two glued plies for feeding the rereeling machine are associated with the embossing device, with it being foreseen that the build up device is actuated at each stopping of the rereeling machine for all of the time taken to discharge a finished log and for the insertion of a core so that the devices upstream of the rereeling machine do not stop and thus the flow of paper is not interrupted.

The present invention refers to an apparatus for rewinding paper into rolls discontinuously without stopping unwinding, in particular for material in paper bands.

In the industry of paper transformation, in particular in the field of the preparation of rolls of toilet paper, of paper for use in the home, kitchen paper and the like, known as “logs”, it is currently known to realise rolls for domestic use with a diameter of 120-130 mm with a length of the wound paper of around ten metres and with glue applied between which strengthens the structure. The use of rolls with a greater diameter known as industrial rolls, which allow greater autonomy of use, but which have no glue applied and are less expensive, is also spreading.

To realise such rolls with a greater diameter starting rolls with at least two plies without glue between them which have a diameter of about two metres are used. The production of these rolls currently takes place through machines known as “start-stop machines” which comprise a winding device for at least two plies of paper arranged in series with an embosser of the at least two plies and with a rereeling machine which stops when the log is complete. Such stopping takes place after every roll in finished so that it can be discharged and so that the core can be introduced.

This type of plant works well without glue between the plies and causes no problem for its alternative operation indicated by their name “start-stop”.

Glue, moreover, is a requirement dictated, indeed, by the type of paper in rolls that the end user likes and that ensures a certain strength.

The application of glue, moreover, is only possible in a new plant which has continuous operation both in winding and unwinding to avoid improper depositing of glue and shut-down of the plant itself, due to smearing thereupon.

The replacement of current “start-stop” plants, moreover, involves a cost which in some cases is unbearable.

The main purpose of the present is therefore that of realising an apparatus for rewinding paper into rolls discontinuously without stopping unwinding, which overcomes the problems of the prior art quoted above, allowing “start-stop” plants that already exist to be used.

Another purpose is that of realising an apparatus which is simple and easy to realise in view of those known up to now.

Yet another purpose is that of realising an apparatus which allows all problems of sticking and smearing to be avoided in the case of stopping of the paper under the glue dispensing device.

These purposes according to the present invention are accomplished by realising an apparatus for rewinding paper into rolls discontinuously without stopping unwinding as outlined in the attached claim 1.

Further relevant characteristics of the present invention are object of the dependent claims.

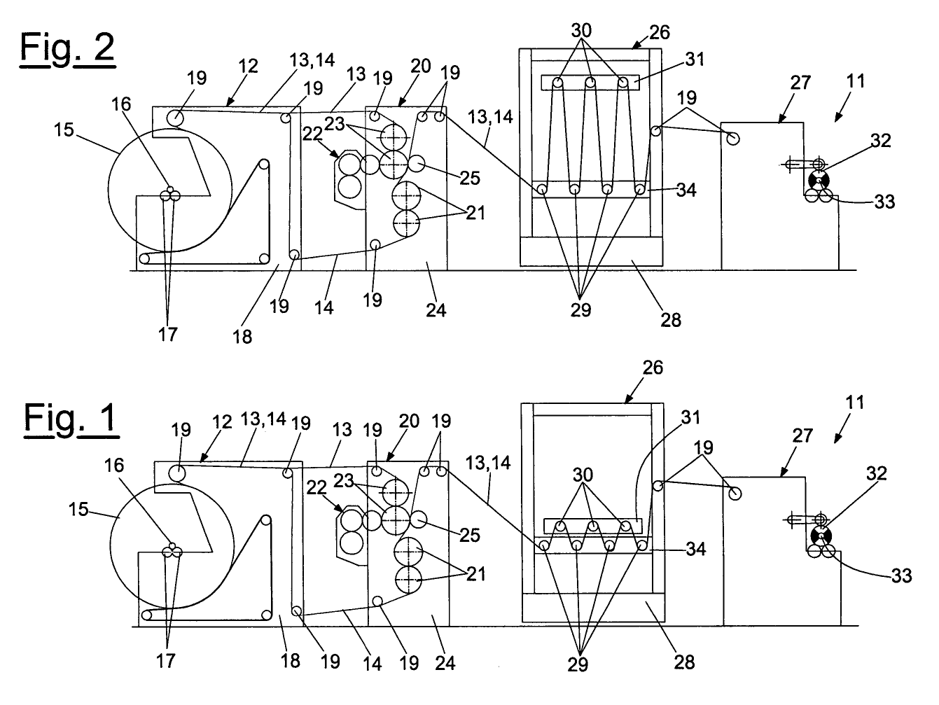

The characteristics and advantages of an apparatus for rewinding paper into rolls discontinuously without stopping unwinding according to the present invention shall become clearer from the following description, given as an example and not for limiting purposes, referring to FIGS. 1 and 2 which show schematic side top views in two different operating steps.

It is indeed with reference to these FIGS. 1 and 2 that an apparatus for winding paper into rolls discontinuously without stopping unwinding is shown, wholly indicated with 11.

Such an apparatus 11 essentially comprises an unwinding device 12 of at least two plies of paper 13, 14 coming from a large reel 15 carried by an axis 16 rotatably arranged on rollers 17 of a bearer structure 18.

The plies 13, 14 passes on deviator rollers 19 and are directed into an embossing device 20 which is arranged in series downstream.

The embossing device 20 foresees other deviator rollers 19 which direct the at least two plies 13, 14, for example one ply 14 to first embossing rollers 21 and the other ply 13 to a glue dispenser 22 arranged before second embossing rollers 23, both arranged on a bearer structure 24.

The two embossed plies 13 and 14, one of which 13 has received glue, are once again arranged one on top of the other by a connection roller 25, where they are made integral with each other, before being sent according to the invention to an build up device 26 arranged before a rereeling machine 27.

The build up device 26 comprises a frame 28 on a beam 34 of which a series of fixed rollers 29 are arranged alternating with a series of vertically mobile rollers 30. These mobile rollers 30 are arranged on beams 31 which can be displaced vertically in the frame 28 so as to determine the winding of a substantial amount of paper in two glued plies 13, 14, which zigzags back and forth between the fixed and mobile rollers.

The build up device 26, in other words the lifting of the beams 31 carrying the mobile rollers 30, is actuated at each stopping of the rereeling machine 27 to discharge a finished log 32 and to insert a core 33 upon which to realise the next log.

The rereeling machine 27 is of the start-stop type which stops each time the log 32 is finished and/or each time a core 33 for a new log must be introduced.

The provision of an build up device 26 like the one described above allows both the unwinding device 12 and the embossing device 20, in which the first embossing rollers 21, the second embossing rollers 23 and the glue dispenser 22 are foreseen, to not be stopped for the whole length of the reel 15.

Continuous glue dispensing is thus obtained without the possibility of there being too much or too little glue on the plies 13, 14, whilst there is still the stopping of the start-stop rereeling machine 27 which stops each time the log 32 is finished and/or each time a core 33 must be introduced for the next fresh log.

Indeed, when the start-stop rereeling machine 27 stops for one of the aforementioned reasons, the paper continues to unwind from the reel 15 passing through the embossing device 20 and the glue dispenser 22. Moreover, the two beams 31 carrying the mobile rollers 30 are made to lift up (FIG. 2), in such a way absorbing a large amount of paper material. Then it is foreseen that the build up device be actuated at each stopping of the rereeling machine for all the discharge time of a finished log and for the insertion of a core so that the devices upstream of the rereeling machine do not stop and thus the flow of paper is not interrupted.

Moreover, the unwinding speed is decreased and all of these provisions ensure that there is no stopping of the paper being unwound with continuous dispensing of glue.

The purposes set previously which form the basis of the present invention are thus achieved and the substantial advantages of such an apparatus are clear.

It is clear how such a solution allows all plants to be modified where there is a start-stop rereeling machine 27 and where the embossing device 20 has no glue dispenser.

Indeed, it is sufficient to separate the embossing machine without glue from the rereeling head and to insert an embossing machine with a glue dispenser to have a completely functional plant that works like a new plant with glue. Moreover, the cost is substantially reduced since just one device is replaced and possibly the motors, for example that of the unwinder, are made independent.

The apparatus of the present invention thus conceived is susceptible to numerous modifications and variants, all covered by the invention itself.

Moreover, in practice the materials used, as well as the sizes and the components, can be whatever according to the technical requirements.

1. Apparatus for rewinding paper into rolls discontinuously without stopping unwinding comprising an unwinding device (12) of at least two plies of paper (13, 14) arranged in series with an embossing device (20) of the at least two plies and with a rereeling machine (27) which stops when a log is completed, characterised in that a gluing device (22) of the at least two plies of paper (13, 14) and an build up device (26) of the at least two glued plies for feeding the rereeling machine (27) are associated with the embossing device (20), with it being foreseen that the build up device (26) is actuated at each stopping of the rereeling machine (27) for all of the time taken to discharge a finished log and for the insertion of a core so that the devices upstream of the rereeling machine do not stop and thus the flow of paper is not interrupted.

2. Apparatus according to claim 1, characterised in that said build up device (26) comprises a frame (28) on which a series of fixed rollers (29) are arranged alternating with a series of vertically mobile rollers (30), wherein said at least two glued plies (13, 14) are inserted zigzagging back and forth between a fixed roller and a mobile roller.

3. Apparatus according to claim 1, characterised in that said embossing device (20) comprises a bearer structure (24) on which deviator rollers (19) are arranged which direct one ply (14) to first embossing rollers (21) and the other ply (13) of said at least two plies (13, 14) to said glue dispenser (22) arranged before second embossing rollers (23).

4. Apparatus according to claim 1, characterised in that said unwinding device (12), said embossing device (20), said build up device (26) and said rereeling machine (27) have independent motors.
